(19) United States
(12) Patent Application Publication
(10) Pub. No.: US 2007/0074670 A1
(43) Pub. Date: Apr. 5, 2007

(54) Pet food container and pet training method

(76) Inventor: Philip Edwards, Grosse Pointe Farms, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/243,651

(22) Filed: Oct. 5, 2005

(51) Int. Cl. A01K 5/00

(52) U.S. Cl. 119/65

(57) ABSTRACT

A pet food container assembly having a container which is dimensioned to enclose pet food. A noisemaker is attached to the pet food container and the noisemaker is selectively activated by a user prior to dispensing food from the container to the pet in order to train the pet.

### BACKGROUND OF THE INVENTION

I. Field of the Invention

The present invention relates to a pet food container assembly and a method for training a pet.

II. Description of Related Art

There are many different kinds of pet foods and particularly pet treats which are dispensed from food containers of one sort or another. In many cases, the pet food container includes a plastic film bag in which the pet treats are contained.

While these previously known pet food containers have adequately contained pet food, none of them have functioned in any fashion to actually train the pets by use of the food contained within the food container.

### SUMMARY OF THE PRESENT INVENTION

The present invention provides a pet food container which overcomes all of the above-mentioned disadvantages of the previously known devices.

In brief, the pet food container assembly of the present invention comprises a container which is dimensioned to contain pet food, such as pet treats. Preferably, the container is constructed from a flexible plastic film, such as a standup pouch bag. Other types of food containers, however, may be utilized without deviation from either the spirit or scope of the invention.

A noisemaker, such as a squeaker, a whistle or a clicker, is attached to the bag. This noisemaker may be contained either within the interior of the bag or may be positioned exteriorly of the bag. Similarly, any conventional means may be used to secure the noisemaker to the container. For example, the noisemaker may be attached by an adhesive to the container.

In practice, the pet owner activates the noisemaker to produce a sound audible to the pet prior to dispensing food from the container to the pet. In this fashion, the pet may be easily and rapidly trained to appear in response to the sound from the noisemaker in anticipation of receiving a treat. After a relatively short period, the pet will respond to the noisemaker regardless of whether or not the pet actually receives the pet treat.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is an elevational view of a preferred embodiment of the invention;

FIG. 2 is a fragmentary sectional view illustrating a modification of the invention;

FIG. 3 is a view similar to FIG. 2 but illustrating still a further modification thereof; and

FIG. 4 is a view similar to FIGS. 2 and 3, but illustrating still a further modification thereof.

### DETAILED DESCRIPTION OF A PREFERRED EMBODIMENT OF THE PRESENT INVENTION

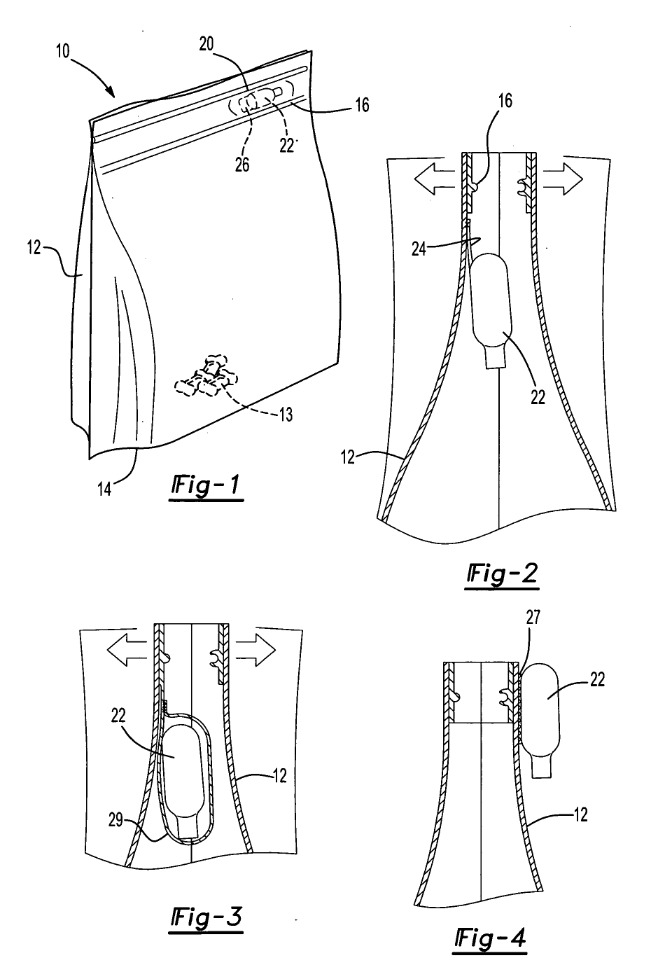

With reference first to FIG. 1, a preferred embodiment of the pet food container assembly 10 of the present invention is shown and includes a container 12 which is dimensioned to contain pet food 13, such as pet treats. Preferably, the food container 12 comprises a flexible film plastic standup pouch bag which may be supported by its bottom 14 for upright display at a retail establishment.

Still referring to FIG. 1, the food container 12 preferably includes a first resealable seal strip 16 across the top of the container 12. This strip 16 enables the user to selectively access the pet food 13 contained within the container 12 and, after accessing the food 13, reseal the container 12.

In addition to the resealable strip 16, the food container 12 preferably includes a permanent seal 20 at a position spaced from the resealable strip 16. The permanent seal 20 ensures that the pet food 13 contained within the interior of the container 12 remains fresh until sold. When sold, the user removes or tears the permanent seal 20 which, in turn, provides access to the resealable strip 16.

With reference now to FIG. 2, a noisemaker 22 is attached to the container 12. As illustrated in FIG. 2, the noisemaker 22 is attached to an interior surface of the container 12 by an adhesive 24 and between the noisemaker 22 and the container 12. Although the noisemaker is illustrated at a position below the seal 16 in FIG. 2, it may alternatively be positioned between the seals 20 and 16 as shown in FIG. 1.

Although the noisemaker 22 is illustrated in FIG. 2 as attached to an interior surface of the container 12 by the adhesive 24, any conventional means may be utilized to attach the noisemaker 22 to the container 12. For example, as best shown in FIG. 1, the noisemaker 22 may include a flash portion 26. This flash portion 26 is then attached to the container 12 by entrapping the flash portion 26 in between the opposing sides of the permanent seal 20. Upon doing so, the seal 20 attaches the flashing 26 to the container 12 which, in turn, attaches the noisemaker 22 to the container 12.

As best shown in FIG. 3, the noisemaker 22 may alternatively be mechanically secured to the container 12 by a strap 29.

As best shown in FIG. 4, the noisemaker 22 may alternatively be attached to an outside surface of the container 12. Again, any conventional means, such as an adhesive 27, may be used to secure the noisemaker 22 to the outer surface of the container 12.

The noisemaker 22 may take any of several forms. For example, the noisemaker 22 may comprise a squeaker, a clicker, a whistle or any other device which produces an audio signal audible to the pet when activated by the user. That audio signal, however, is not necessarily audible to a human being.

In operation, once the container 12 has been opened by removing the permanent seal 20, the noisemaker 22 is activated by the user prior to dispensing the pet food 13, preferably a pet treat, from the container 12 and to the pet. During pet training, the noisemaker 22 is activated by the user to produce the audible sound prior to each time the pet food 13 is dispensed from the container 12.

After a period of time, the pet will automatically appear or “come” in response to the sound of the noisemaker 22 in anticipation of receiving the pet food 13. This pet response will continue even though the pet does not receive the pet food 13 from the container 12 following activation of the noisemaker 22.

Consequently, after the pet has been fully trained using the pet food container assembly 10 of the present invention, the pet may be rapidly located by merely activating the noisemaker 22 whereupon the pet will immediately appear at the source of the noisemaker 22.

From the foregoing, it can be seen that the present invention provides a novel food container assembly and method for training a pet. Having described my invention, however, many modifications thereto will become apparent to those skilled in the art to which it pertains without deviation from the spirit of the invention as defined by the scope of the appended claims.

I claim:

1. A pet food container assembly comprising:
a container dimensioned to enclose pet food,
a noisemaker attached to said container, said noisemaker being selectively activated by a user.

2. The invention as defined in claim 1 wherein said container comprises a bag.

3. The invention as defined in claim 2 wherein said bag comprises a flexible plastic film bag.

4. The invention as defined in claim 1 wherein said noisemaker comprises a squeaker.

5. The invention as defined in claim 1 wherein said noisemaker comprises a clicker.

6. The invention as defined in claim 1 wherein said noisemaker comprises a whistle.

7. The invention as defined in claim 1 wherein said noisemaker is attached to said container by an adhesive.

8. The invention as defined in claim 1 wherein said container comprises a seam, and wherein said noisemaker includes a portion entrapped in said seam.

9. The invention as defined in claim 1 wherein said noisemaker is attached to an interior surface of said container.

10. The invention as defined in claim 1 wherein said noisemaker is attached to an exterior surface of said container.

11. A method for training a pet comprising the steps of:
attaching a noisemaker to a pet food container,
activating said noisemaker to emit a sound audible to a pet prior to dispensing food from the container to the pet.

12. The invention as defined in claim 10 wherein the noisemaker comprises a squeaker.

13. The invention as defined in claim 10 wherein the noisemaker comprises a clicker.

14. The invention as defined in claim 10 wherein said noisemaker comprises a whistle.

15. The invention as defined in claim 10 wherein the food container comprises a bag.

16. The invention as defined in claim 13 wherein said bag comprises a flexible plastic film bag.
